(19) United States
(12) Patent Application Publication
(10) Pub. No.: US 2003/0061252 A1
(43) Pub. Date: Mar. 27, 2003

(54) Non-constant reduced-complexity multiplication in signal processing transforms

(76) Inventor: Charles D. Murphy, Chicago, IL (US)

Correspondence Address: CHARLES DOUGLAS MURPHY, 601 LINDEN PLACE #210, EVANSTON, IL, 60202, US

(21) Appl. No.: 09/963,623

(22) Filed: Sep. 27, 2001

(51) Int. Cl. G06F 7/00

(52) U.S. Cl. 708/603

(57) ABSTRACT

A machine or method used in signal processing transforms involving computing one or more sums each of one or more products. A multiplier has one or both of its two inputs restricted to limited sets of numbers having given finite-precision numeric formats. The multiplier is not a constant multiplier capable only of computing the product of any first number and a constant. The multiplier is not a general multiplier capable of computing the product of any pair of numbers. The multiplier has lower complexity than a general multiplier, but more flexibility than a constant multiplier. The invention can be used to reduce the overall computational complexity of signal processing transforms. The invention can be used when transform weights are fixed and known. The invention can be used when transform inputs, though random, come from small, known sets, as is the case in digital communications.

### STATEMENT REGARDING FEDERALLY SPONSORED RESEARCH OR DEVELOPMENT

Not applicable

### REFERENCE TO A MICROFICHE APPENDIX

Not applicable

### BACKGROUND

1. Field of Invention

The invention relates to number transforms used in signal processing, specifically to computing products using multiplication techniques that require at least one input from a restricted set having at least two members.

2. Description of Prior Art

Signal processing involves manipulation of one or more input signals in order to produce one or more output signals. In digital signal processing, the signals are represented by numbers. The numbers have finite-precision representations in particular formats. Well-known formats include binary twos-complement, signed integer, unsigned integer, and floating point, among others.

Arithmetic operations are basic tools of digital signal processing. Two of the most important arithmetic operations are multiplication and addition. In some important technologies, such as application specific integrated circuits, field-programmable gate arrays, and general purpose microprocessors, a multiplication operation may be much more expensive than an addition operation, in terms of chip space, power consumed, processor cycles, or some other measure. For such technologies, the complexity of a signal processing transform is often measured by the number of multiplication operations the transform requires.

A general multiplier is a circuit or sequence of operations that is able to compute the product of any two numbers. It is possible that the two numbers and the resulting product do not have the same finite-precision numeric format, but the two numbers can take on all possible values permitted by their respective formats. A general multiplier is particularly useful because it can be re-used within an application or for different applications. A general multiplier has the advantage of being very flexible, and the disadvantage of being relatively complex to implement.

There are many general multiplier machines and methods. General multipliers may exist as standard software instruction sets, as hardware in an arithmetic and logic unit or on a DSP chip, and in other forms.

A constant multiplier is a circuit or sequence of operations that is able to compute the product of a first number that can take on any value permitted by its numeric format and a second number which is a constant. Because the second number is restricted to having a single value, the complexity of the multiplication can be greatly reduced. A constant multiplier has the advantage of having relatively low implementation complexity, and the disadvantage of being inflexible.

Constant multipliers and techniques for designing constant multipliers appear in U.S. Pat. No. 6,223,197 (issued to K. Kosugi on Apr. 24, 2001), in U.S. Pat. No. 5,903,470 (issued to A. Miyoshi and T. Nishiyama on May 11, 1999), in U.S. Pat. No. 5,841,684 (issued to K. Dockser on Nov. 24, 1998), in U.S. Pat. No. 5,815,422 (issued to K. Dockser on Sep. 29, 1998), in U.S. Pat. No. 5,600,569 (issued to T. Nishiyama and S. Tsubata on Feb. 4, 1997) and in U.S. Pat. No. 5,159,567 (issued to J. Gobert on Oct. 27, 1992). A common feature of all these prior art constant multipliers is an attempt to minimize the cost of a multiply operation when one of the numbers being multiplied is a known constant.

A large number of signal processing transforms utilize sums of products. Examples of such transforms include the discrete Fourier transform (DFT), the inverse discrete Fourier transform, the discrete cosine transform (DCT), and digital filters implementing pulse shaping for digital communications. Typically, the transforms have a set of allowed inputs, a set of desired outputs, and a set of known, fixed weights. The outputs are sums of weighted inputs. These transforms can be computed using general multipliers. In this case, one or more general multipliers can be used to compute all of the weighted inputs. These transforms can also be computed using constant multipliers. In this case, one constant multiplier is required for each unique constant value.

An example of a real-time application of a signal processing transform is orthogonal frequency division multiplexing, or OFDM, a digital communications technique. In a typical OFDM system, an inverse DFT is used to modulate data symbols at the transmitter. At the receiving end of the channel, a DFT is used to demodulate the received signal and to recover the data.

The main advantages of the DFT and the inverse DFT in OFDM are the existence of fast Fourier transform techniques with low multiplication complexity and that the transforms simplify channel identification and equalization. The weights of the transmitting transform are fixed and known in advance, while the inverse DFT inputs are from known sets of allowed transmitted symbols.

Fast Fourier transforms often reduce multiplication complexity by decomposing a DFT or an inverse DFT into sets of smaller Fourier transforms. This eliminates redundant multiplications that are present in direct computation. Recursive decomposition can lead to transforms that require few or no multiplications, such as 2, 4, or 8 point transforms. The unit-amplitude complex weights for these are all either purely real, purely imaginary, or have real and imaginary components of equal amplitude.

Another technique for reducing the multiplication complexity of a DFT or inverse DFT given particular transform sizes and numeric formats is to replace multiplication by powers of two with shifting operations.

In actual implementations, DFT computation using fast Fourier transform techniques uses structures that have non-negligible numbers of multiplication operations for reasonable transform sizes. These may be general multiplications, with some low-complexity special-use implementations having constant multiplications.

The DFT, the inverse DFT, and other transforms are used in digital communications, and also in such areas as sonar, radar, speech, image, biomedical, and video signal processing. Whether or not a particular transform is or is not practical depends in large part on the economic cost of building a device to compute the transform and on technological limitations. Many signal processing transforms rely heavily on the basic operation of multiplication for signal manipulation. Low-complexity multiplication is a desirable to enable practical signal processing systems.

The disadvantages of prior art multipliers such as general multipliers and constant multipliers used in signal processing transforms are the following:

a. In some technologies, such as an application-specific integrated circuit (ASIC), a field-programmable gate array (FPGA), or software, the cost of a general multiplier is very high in terms of chip space, consumed power, processing cycles, or other measures.

b. Many signal processing transforms have fixed weights, so that the full capabilities of a general multiplier are not necessary, even though a general multiplier is very flexible.

c. A constant multiplier may have relatively low complexity of implementation, but lacks flexibility. It cannot be re-used within a signal processing transform unless one of its inputs happens to equal the constant.

d. Many signal processing transforms have several different fixed weights, so that several different constant multipliers may be needed in a given transform.

e. Some signal processing transforms, such as the modulating inverse DFT in an OFDM system, have both known, fixed weights and inputs that take on a very small number of values.

f. Low overall cost in terms of chip space, consumed power, processing cycles, or other measures is a desirable feature of signal processing transforms, but separately minimizing the cost of each part of a whole does not necessarily minimize the overall cost of the whole.

### SUMMARY

The present invention is a technique for computing products of numbers using a multiplier that is neither a general multiplier capable of computing the product of any two numbers nor a constant multiplier capable only of computing the product of any first number and a constant.

Objects and Advantages

Accordingly, several objects and advantages of the present invention are that:

a. using said invention, multiplication of two numbers can be accomplished without using a general multiplier, at a cost less than that of using a general multiplier

b. using said invention, multiplication of several pairs of numbers can be accomplished without using several separate constant multipliers, at a cost less than that of using several separate constant multipliers

c. using said invention, multiplication complexity reduction can take into account restrictions on one or both of a pair of numbers to be multiplied

d. using said invention, the overall complexity of a signal processing transform can be minimized

Further objects and advantages of the invention will become apparent from a consideration of the drawings and ensuing description.

### DRAWING FIGURES

Not applicable

### REFERENCE NUMERALS IN DRAWINGS

Not applicable

### DESCRIPTION

### Signal Processing Transforms

Signal processing is widely used in such areas as digital communications, radar, sonar, astronomy, geology, control systems, image processing, and video processing. In digital signal processing, the signals are represented by numbers. Input signals or numbers are manipulated by signal processing transforms to produce output signals or numbers. The input numbers, the output numbers, and intermediate terms take on values from finite sets. The allowed values for a particular number are determined by a finite-precision numeric format and possibly by other restrictions. Examples of restrictions are constant weights, such as those of discrete Fourier transforms, or the limited set of symbol values in a digital communications system.

Arithmetic operations are important tools in signal processing. Two of the most important are multiplication and addition. Many signal processing transforms compute sums of products. When the complexity of implementing a multiplication is much higher than the complexity of implementing an addition, the cost of a signal processing transform may be measured by its overall multiplication complexity.

A general multiplier is a circuit or a sequence of operations that can compute the product of two numbers, each of which can have any value allowed by its numeric format. A general multiplier is very flexible and can be re-used within a signal processing transform or in another application, but it can also be very complex to implement.

A constant multiplier is a circuit or a sequence of operations that computes the product of a first number and a constant, with the first number allowed to take on any value allowed by its numeric format. A constant multiplier is not very flexible and can seldom be re-used within a signal processing transform or in another application, but can have relatively low-cost implementations.

General multipliers for digital computation have been implemented in software and in hardware for particular technologies. There are standard circuits or instruction sets capable of computing a general multiplication, so that a system designer need not focus on the details of multiplication. However, in some cases a signal processing transform may use a fixed weight repeatedly, and the application and implementation technology in question may have strict cost limitations. For these situations, constant multipliers have been proposed as a way to reduce multiplier complexity. There is not necessarily a set of standard circuits or instruction sets for an individual constant multiplier, but automated design programs are capable of producing efficient constant multiplier circuits or instruction sets.

Examples of prior art constant multipliers and design techniques include those in U.S. Pat. No. 6,223,197 (issued to K. Kosugi on Apr. 24, 2001), in U.S. Pat. No. 5,903,470 (issued to A. Miyoshi and T. Nishiyama on May 11, 1999), in U.S. Pat. No. 5,841,684 (issued to K. Dockser on Nov. 24, 1998), in U.S. Pat. No. 5,815,422 (issued to K. Dockser on Sep. 29, 1998), in U.S. Pat. No. 5,600,569 (issued to T. Nishiyama and S. Tsubata on Feb. 4, 1997) and in U.S. Pat. No. 5,159,567 (issued to J. Gobert on Oct. 27, 1992). Each of these examples is concerned with implementing a multiplication when one of two numbers being multiplied is constant. In various ways they attempt to minimize the complexity of the multiplication by exploiting the properties of the constant. They do not, however, consider any restrictions placed on the number being multiplied by the constant, nor the possibility of a multiplier that is not a general multiplier and that is also not a constant multiplier.

Other examples of prior art constant multipliers that have lower complexity than and that replace general multipliers are found in computation of discrete Fourier transforms and inverse discrete Fourier transforms. In discrete Fourier transforms, the weights applied to transform inputs are unit-amplitude complex numbers. With a phase of 0, π/2, π, or 3π/2, the weights are purely imaginary or purely real, and multiplication can be implemented using the operations of negation and exchange of real and imaginary components.

With a phase of π/4, 3π/4, 5π/4, or 7π/4, the real and imaginary components of the weight have the same amplitude. Multiplication of a complex number by these complex weights can be implemented with two real multiplications instead of three or four real multiplications. Such a reduced-complexity complex number multiplier is not a general complex number multiplier.

A third example from computation of an inverse discrete Fourier transform is replacement of general multiplication by a power of two with a constant multiplication. The constant multiplication is implemented by a shifting operation. One requirement for using this constant multiplier is a transform size that has factors that are powers of two, preferably only factors that are powers of two. Another requirement is a finite-precision numeric format in which shifting contiguous sets of representation elements results in power-of-two scaling. With representation elements capable of taking on ten values (e.g. digits), power-of-ten multiplication could be implemented by shifting digits.

### Claim 1 and the Preferred Embodiment

The preferred embodiment of the invention uses a multiplier that is not a general multiplier capable of multiplying any two numbers, and that is also not a constant multiplier that can only multiply any number by a constant. The multiplier in the preferred embodiment of the invention is not as flexible as a general multiplier, and at the same time is more flexible than a constant multiplier. It is more complex than a constant multiplier, and at the same time it is not as complex as a constant multiplier. This makes it a useful tool in signal processing transforms having several fixed, known weights and in signal processing transforms with numbers that come from small known sets of numbers.

The preferred embodiment of the invention is described in claim 1. It is a machine used in computing one or more sums of products, comprising a first number in a first finite-precision numeric format, a second number in a second finite-precision numeric format, and first multiplier means for computing the product of the first number and the second number.

The first number has a first finite number of representation elements and the second number has a second finite number of representation elements. One type of representation element is a binary representation element which can take on two possible values. Such a representation element is often called a “bit”. Other types of representation elements are possible. The invention as described by claim 1 does not require that the first finite-precision numeric format be the same as the second finite-precision numeric format. The invention as described by claim 1 also does not require that the representation elements be binary representation elements.

The first number of claim 1 is restricted. It must be a member of a first multiplier-defined restricted set. This first multiplier-defined restricted set does not include all the numbers having the first finite-precision numeric format. However, the first multiplier-defined restricted set does include more than one member. The second number of claim 1 is not restricted. It is possible that the second number takes on any value allowed by the second finite-precision numeric format.

The first multiplier means in claim 1 can compute the product of a first multiplier input and a second multiplier input when the first multiplier input is a member of the first multiplier-defined restricted set and the second multiplier input is the second number. The first multiplier means in claim 1 cannot compute the product of a first multiplier input and a second multiplier input when the first multiplier input is not a member of the first multiplier-defined restricted set, the second multiplier input is the second number, and neither the first multiplier input nor the second multiplier input have numeric value equal to zero.

The first multiplier-defined restricted set includes all the numbers having the first finite-precision numeric format for which the first multiplier means can produce correct products when multiplying by the second number. Since the first multiplier-defined restricted set does not include all numbers having the first finite-precision numeric format, the first multiplier means is not a general multiplier for numbers in the first finite-precision numeric format. Since the first multiplier-defined restricted set has more than one member, the first multiplier means is not be a constant multiplier.

A further restriction imposed by claim 1 is that at least one of the one or more sums of products in which the machine of claim 1 is used is not a desired product of two numbers. Any product of two numbers can be computed as a sum of products by separating one or both of the numbers into equivalent sums and applying the distributive property of multiplication. The language in claim 1 restricting the sum of products being computed to not being a desired product of two numbers is intended to avoid conflict with this interpretation of product computation. Claim 1 should not cover a signal processing transform that is in fact a multiplier. Claim 1 should cover signal processing transforms that use sums of products and that are not themselves multipliers.

### Claim 2 Through Claim 9

Dependent machine claim 2 restricts claim 1 by requiring that the first multiplier-defined restricted set include the numeric value zero. Thus the first multiplier means must be able to produce the product of zero and the second number. This is an important distinction because it is possible to design a multiplier that cannot multiply by zero, and because circuitry or instructions to provide a zero-valued multiplier output may have very low complexity in technologies in which a general multiplier is expensive. A multiplier that cannot multiply by zero and the same multiplier with additional circuitry or instructions for zero multiplication are different multipliers, but may have very similar implementation cost.

Dependent machine claim 3 requires the first multiplier-defined restricted set to have a first member with numeric value not equal to zero, positive one, or negative one and a second member with numeric value not equal to zero, positive one, or negative one. The alternative embodiment of the invention described by claim 3 has a multiplier that is capable of computing products involving other operations than negation and zero multiplication.

Dependent machine claim 4 restricts the first multiplier-defined restricted set to having exactly two members. This embodiment of the invention can have complexity that is very close to that of prior art constant multipliers, without actually implementing a constant multiplier.

Dependent machine claim 5 further restricts dependent machine claim 4 to having one member of the first multiplier-defined restricted set be zero. As mentioned in the above discussion of claim 2, circuitry or instructions for zero multiplication may have very low complexity and can be combined with a constant multiplier to make a low-complexity embodiment of the present invention.

Dependent machine claim 6 further restricts dependent machine claim 4 to having members which are the negatives of each other. Circuitry or instructions for negation may have very low complexity and can be combined to make a low-complexity embodiment of the present invention.

Dependent machine claim 7 further restricts dependent machine claim 4 to having members which are related to one another by shifting operations. As with zero-multiplication and negation, shifting can be a very simple operation to implement.

There are various low-complexity ways to relate exactly two numbers other than negation only and shifting only. For instance, it is possible to use a combination of shifting, negation, and addition operations. Any embodiment of the invention with exactly two numbers in the first multiplier-defined restricted set should be covered by dependent machine claim 4, however.

Dependent machine claim 8 requires that the first multiplier-defined restricted set of claim 1 have more than two members. Claim 8 is intended to cover the broad range of non-constant, non-general multipliers between those of claims 4 through 7 and general multipliers. The invention embodiments of claims 4 through 7 are important because they offer extremely low-complexity embodiments of the invention. The invention embodiment of claim 8 is important because it offers increasing flexibility at the cost of increasing complexity.

Dependent machine claim 9 requires that the first multiplier-defined restricted set of claim 1 have a first member and a second member each of which is not an integer multiple of the other. The embodiment of the invention as described by claim 9 reinforces the idea that a non-constant, non-general multiplier can have a first multiplier-defined restricted set that comprises numbers not related by shifting and negation only or by addition and negation only. The first member and second member of the first multiplier-defined restricted set of claim 1 are related by at least one shift operation and at least one addition operation.

### Claim 10 to Claim 12

Dependent machine claim 10 includes the elements of claim 1 and in addition a third number, a fourth number, and second multiplier means for computing a second product equal to the product of the third number and the fourth number.

The third number is in a third finite-precision numeric format and is a member of a second multiplier-defined restricted set. The fourth number is in a fourth finite-precision numeric format. The second multiplier-defined restricted set has more than one member.

One property of the second multiplier means is that it can compute the product of a first multiplier input and a second multiplier input when the first multiplier input is any member of the second multiplier-defined restricted set and the second multiplier input is the fourth number. Another property of the second multiplier is that it cannot compute the product of a first multiplier input and a second multiplier input when the first multiplier input is not a member of the second multiplier-defined restricted set, the second multiplier input is the fourth number, the first multiplier input has numeric value not equal to zero, and the second multiplier input has numeric value not equal to zero.

As described in claim 10, an alternative embodiment of the invention can use a non-constant, non-general first multiplier in conjunction with a non-constant second multiplier. If the second multiplier-defined restricted set includes all of the numbers having the third finite-precision numeric format, the second multiplier may be a general multiplier for numbers in the third finite-precision numeric format.

In dependent claim 11, the machine claim 10 is restricted to having a second multiplier-defined restricted set that does not include all of the numbers having the third finite-precision numeric format. An embodiment of the invention as described by claim 10 uses non-constant, non-general first multiplier means and non-constant, non-general second multiplier means.

Dependent machine claim 12 restricts the first multiplier-defined restricted set and the second multiplier-defined restricted set to having no common members. Thus the first multiplier means is not able to compute the product of the second number and a member of the second multiplier-defined restricted set. Also, the second multiplier means is not able to compute the product of the fourth number and a member of the first multiplier-defined restricted set. In a practical signal processing application, several different multipliers can be used, each designed to be able to compute separate sets of products. The structure of each multiplier can be optimized separately.

In claims 10 through 12, no restrictions were placed on the third and fourth finite-precision numeric representations. It is possible for the two multipliers to have inputs in differing finite-precision representations. Note that two numbers with the same numeric value but differing finite-precision numeric formats are different numbers.

### Claim 13

Dependent machine claim 13 requires that the second number of claim 1 be a member of a second multiplier-defined restricted set. The first multiplier means of claim 1 are required to be able to compute the product of a first multiplier input and a second multiplier input when the first multiplier input is a member of the first multiplier-defined restricted set and the second multiplier input is a member of the second multiplier-defined restricted set. The first multiplier means can compute the product of any number in the first multiplier-defined restricted set and any number in the second multiplier-defined restricted set.

In contrast, the first multiplier means cannot compute the product of a first multiplier input and a second multiplier input when the first multiplier input is a member of the first multiplier-defined restricted set, the second multiplier input is not a member of the second multiplier-defined restricted set, and both the first multiplier input and the second multiplier input have numeric values not equal to zero. The first multiplier means also cannot compute the product of a first multiplier input and a second multiplier input when the first multiplier input is not a member of the first multiplier-defined restricted set, the second multiplier input is a member of the second multiplier-defined restricted set, and both the first multiplier input and the second multiplier input have numeric values that are not equal to zero.

The second multiplier-defined restricted set does not have as members all the numbers having the second finite-precision numeric format.

The invention as embodied by claim 13 is a multiplier that can multiply any member of a strict subset of numbers in the first finite-precision numeric format by any number in a strict subset of numbers in the second finite-precision numeric format. Because there are restrictions on both inputs, it may be possible that the first multiplier means of claim 13 can be implemented with lower complexity than if there were restrictions on only one input.

A particular example of an application in which the embodiment of the invention described in claim 13 is useful is in orthogonal frequency division multiplexing (OFDM). OFDM is a digital communications technique in which a transmitter uses an inverse discrete Fourier transform to modulate successive blocks of data symbols. The data symbols are inputs to the transform, and come from symbol constellations. The symbol constellations usually have a small number of known, allowed symbol values. Whether the transform outputs are computed directly or using fast Fourier transform techniques, inputs, weights, and intermediate terms are all members of restricted sets. The embodiment of the invention described in claim 13 is intended to have multipliers that exploit possible restrictions on both multiplier inputs rather than restrictions on just one input.

### Claim 14 Through Claim 16

Dependent machine claim 14 restricts the second multiplier-defined restricted set of claim 13 to having exactly one member. This embodiment of the invention uses first multiplier means that can multiply any number in the first multiplier-defined restricted set by a constant. It is not a constant multiplier for numbers having the first finite-precision numeric format because the first multiplier-defined restricted set does not have as members all of the numbers having the first finite-precision numeric format.

Dependent machine claim 15 restricts the one member of the second multiplier-defined restricted set of claim 14 to having a numeric value that is not equal to zero, positive one, or negative one. This emphasizes that the invention of claim 14 can be implemented with any constant. In particular, constants with numeric value not equal to zero, positive one, or negative one offer the greatest potential for complexity reduction relative to general multipliers and prior-art constant multipliers.

Dependent machine claim 16 requires that the second multiplier-defined restricted set of claim 13 have more than one member. Embodiments of the invention as described by claim 16 are very useful in ODFM digital communications systems when a flexible but low-complexity multiplier is desired.

### Claim 17

Independent method claim 17 is an embodiment of the invention providing first multiplication of a first number by a second number. The first number is represented in a first finite-precision numeric format and is a member of a first multiplication-defined restricted set. The second number is represented in a second finite-precision numeric format.

The multiplication method used in the embodiment of the invention described in claim 17 has several special properties. It can produce the product of a first multiplication input and the second number when the first multiplication input is a member of the first multiplication-defined restricted set. It cannot produce the product of a first multiplication input and the second number when the first multiplication input is not a member of the first multiplication-defined restricted set, the first multiplication input is not zero, and the second number is not zero.

The first multiplication-defined restricted set is required to have more than one member, and cannot include every number having the first finite-precision numeric format. Thus the first multiplication method is not a general multiplication method, and also is not a constant multiplication method. It can be less complex than a general multiplication method and can also be more flexible than a constant multiplication method.

The method of claim 17 does not require that the first finite-precision representation format be the same as the second finite-precision representation format. It does not require that the representation elements have a particular number of possible states. The second number is not restricted except by its format. It is possible that the second number may take on any value permitted by the second finite-precision numeric format.

To avoid conflict with multiplication methods that themselves implement sums of products, the embodiment described in claim 17 is a method required to be used in computing one or more sums of products where at least one sum is not a desired product of two numbers.

### Claim 18 Through Claim 25

Dependent method claim 18 restricts method claim 17 to having as a member of the first multiplication-defined restricted set the number zero. This zero member may or may not be represented in the first finite-precision numeric format.

Dependent method claim 19 restricts the first multiplication-defined restricted set of method claim 17 to having a first member with numeric value not equal to zero, positive one, or negative one and a second member with numeric value not equal to zero, positive one, or negative one.

Dependent method claim 20 restricts the first multiplication-defined restricted set of method claim 17 to having exactly two members. Dependent method claim 21 restricts one of the two members of the first multiplication-defined restricted set of claim 20 to being the number zero. Dependent method claim 22 restricts each of the two members of the first multiplication-defined restricted set of claim 20 to being the negative of the other. Dependent method claim 23 restricts each of the two members of the first multiplication-defined restricted set of claim 20 to being a shifted version of the other.

Dependent method claims 20 through 23 are intended to cover a variety of low-complexity implementations of the multiplication method of claim 17 which have complexity comparable to the complexity of constant multiplication methods, but which are not constant multiplication methods.

Dependent method claim 24 further requires that the first multiplication-defined restricted set of method claim 17 have more than two members. Dependent method claim 24 is intended to cover a wide variety of multiplication methods with complexity between general multiplication methods and constant multiplication methods or the multiplication methods of claims 20 through 23.

Dependent method claim 25 requires that the first multiplication-defined restricted set of claim 17 have a first member and a second member each of which is not an integer multiple of the other. The embodiment of the invention as described by claim 25 reinforces the idea that a non-constant, non-general multiplication method can have a first multiplication-defined restricted set that comprises numbers not related by shifting and negation only or by addition and negation only. The first member and second member of the first multiplication-defined restricted set of claim 17 are related by at least one shift operation and at least one addition operation.

### Claim 26 Through Claim 28

Dependent method claim 26 further requires a second multiplication of a third number by a fourth number to produce a second product. The third number is in a third finite-precision numeric format and the fourth number is in a fourth finite-precision numeric format. The third number is a member of a second multiplication-defined restricted set. The second multiplication-defined restricted set has more than one member.

The method of the second multiplication in claim 26 has two special properties. It can compute the product of a first multiplication input and the fourth number when the first multiplication input is a member of the second multiplication-defined restricted set. It cannot compute the product of a first multiplication input and the fourth number when the first multiplication input is not a member of the second multiplication-defined restricted set, the first multiplication input has numeric value not equal to zero, and the fourth number has numeric value not equal to zero.

The embodiment of the invention described in claim 26 uses a non-constant, non-general method for first multiplication and a non-constant method for second multiplication. Dependent method claim 27 requires that the second multiplier-defined restricted set of claim 26 not include all the numbers having the third finite-precision numeric format. The embodiment of the invention described in claim 27 uses a non-constant, non-general method for first multiplication and a non-constant, non-general method for second multiplication.

Dependent method claim 28 requires that the first multiplication-defined restricted set and the second multiplication-defined restricted set in claim 26 not have any common members. This embodiment of the invention is particularly intended to cover low-complexity signal processing transforms in which multiplication methods are designed strictly for computing separate sets of products.

### Claim 29 Through Claim 32

The embodiment of the invention described in claim 29 requires that the second number of claim 17 be from a second multiplication-defined restricted set. This second multiplication-defined restricted set does not include all numbers having the second finite-precision numeric format. Furthermore, the first multiplication method of claim 17 must be able to compute the product of a first multiplication input and a second multiplication input from the first multiplication-defined restricted set and the second multiplication-defined restricted set respectively.

The first multiplication method cannot compute the product of a first multiplication input and a second multiplication input when the first multiplication input is from the first multiplication-defined restricted set, the second multiplication input is not from the second multiplication-defined restricted set, and both inputs are non-zero. The first multiplication method also cannot compute the product of a first multiplication input and a second multiplication input when the first multiplication input is not from the first multiplication-defined restricted set, the second multiplication input is from the second multiplication-defined restricted set, and both inputs are non-zero.

The embodiment of the invention described in claim 29 has a first multiplication-defined restricted set and a second multiplication-defined restricted set. The first multiplication method is able to compute the product of any number from the first multiplication-defined restricted set and any number from the second multiplication-defined restricted set. The first multiplication method is not able to compute the product of a member of one of the sets and a number which is not a member of the other set.

The embodiment of the invention described in claim 29 is intended to cover flexible multiplication methods that exploit limitations on the allowed values of two multiplier inputs. An example of an application where this would be useful is in an OFDM transmitter where inputs come from a limited symbol constellation and the weights of the modulating inverse Fourier transform are fixed and known.

Dependent method claim 30 restricts the second multiplication-defined restricted set of claim 29 to having exactly one member. Claim 30 is intended to cover embodiments of the invention using a first multiplication method with lowest possible complexity. An example of a particular application would be OFDM, in which the second multiplication-defined restricted set could contain a single inverse discrete Fourier transform weight while the first multiplication-defined set could include the symbol constellation values.

Dependent method claim 31 requires that one member of the second multiplication-defined restricted set of claim 30 have numeric value not equal zero, positive one, or negative one. This emphasizes that the invention of claim 30 can be implemented with any constant, and in particular with constants having numeric value not equal to zero, positive one, or negative one.

Dependent method claim 32 requires that the second multiplication-defined restricted set of claim 29 have more than one member. Both the first multiplication-defined restricted set and the second multiplication-defined restricted set have more than one member. This is useful in OFDM, as a single implementation of the embodiment of claim 32 can be used to compute products of several possible transform weights and several possible input values. The implementation can have low cost, and yet can still be flexible.

### CONCLUSION, RAMIFICATIONS, AND SCOPE

The reader will see that the present invention has several advantages over prior art techniques for multiplication of one number by another, particularly in signal processing transforms. The invention is not a general multiplier or general multiplication method capable of computing the product of two numbers that can take on any values allowed by their finite-precision numeric formats. The invention is also not a constant multiplier or constant multiplication method capable of computing the product of a constant a number that can take on any value allowed by its finite-precision numeric format.

The invention is a multiplier or multiplication method that has greater complexity and greater flexibility than a constant multiplier or constant multiplication method. The invention is a multiplier or multiplication method that has lower complexity and lower flexibility than a general multiplier or general multiplication method.

In one embodiment of the invention, restrictions on the allowed values of one multiplier input can be exploited to produce a reduced-complexity multiplier. In another embodiment of the invention, restrictions on the allowed values of both multiplier inputs can be exploited to produce a low-complexity multiplier.

The invention is used in computing sums of products when at least one of the sums is not a desired product of two numbers. Such situations commonly occur in signal processing transforms. The invention is particularly useful when a signal processing transform has fixed, known weights. If the weights are complex, they may be used in Cartesian coordinates with real multipliers or real multiplication methods according to the invention. Many important signal processing transforms such as discrete Fourier transforms, inverse discrete Fourier transforms, discrete cosine transforms, inverse discrete cosine transforms, and others have fixed, known weights. These transforms are often used repeatedly in an application, and it is desirable to have low-cost implementations of the transforms.

In some applications, there are restrictions on both inputs to a multiplier. This is the case in orthogonal frequency division multiplexing (OFDM). OFDM is a digital communications technique in which data symbols are passed as inputs to a modulating inverse discrete Fourier transform. The data symbols come from a symbol constellation, which is a limited set of allowed symbol values. The inverse discrete Fourier transform weights are fixed and known. In computing the inverse discrete Fourier transform outputs, it is possible to use embodiments of the present invention that exploit knowledge of both the transform weights and the transform inputs. This is possible for both direct computation and for fast Fourier transform techniques.

The invention is not limited to particular number representations or to particular applications. Signal processing transforms that use sums of products are used in digital communications, radar, sonar, astronomy, geology, control systems, image processing, and video processing. Technologies used to implement signal processing transforms include hardware technologies such as application specific integrated circuits and field-programmable gate arrays and software technologies such as multiplication on a general-purpose microprocessor.

The description above contains many specific details relating to finite-precision numeric formats, representations elements, restricted sets, number values, computational complexity measures, discrete Fourier transforms, hardware technologies, software technologies, and signal processing transforms. These should not be construed as limiting the scope of the invention, but as illustrating some of the presently preferred embodiments of the invention. The scope of the invention should be determined by the appended claims and their legal equivalents, rather than by the examples given.

I claim:

1. A machine used in computing one of more sums of products, wherein at least one of said sums of products is not a desired product of two numbers, comprising:
a. a first number represented in a first finite-precision numeric format, said first number being a member of a first multiplier-defined restricted set
b. a second number represented in a second finite-precision numeric format
c. first multiplier means for computing a first product equal to the product of said first number and said second number, where
i. said first multiplier means can compute the product of a first multiplier input and a second multiplier input when the first multiplier input is any number from said first multiplier-defined restricted set and the second multiplier input is said second number
ii. said first multiplier means cannot compute the product of a first multiplier input and a second multiplier input when the first multiplier input is not a member of said first multiplier-defined restricted set, the second multiplier input is said second number, the first multiplier input has numeric value not equal to zero, and the second multiplier input has numeric value not equal to zero
iii. said first multiplier-defined restricted set has more than one member
iv. said first multiplier-defined restricted set does not include all the members of a first unrestricted set, said first unrestricted set including all numbers having said first finite-precision numeric format and not including numbers in other finite-precision numeric formats
whereby said first product may be computed with reduced complexity compared to computation of said first product using general multiplier means, said general multiplier means being able to compute the product of said second number and any member of said first unrestricted set.

2. The machine of claim 1 in which said first multiplier-defined restricted set includes a number having a numeric value zero.

3. The machine of claim 1 in which said first multiplier-defined restricted set includes a first member having numeric value not equal to zero, positive one, or negative one and a second member having numeric value that is not equal to zero, positive one, or negative one.

4. The machine of claim 1 in which said first multiplier-defined restricted set has exactly two members.

5. The machine of claim 4 in which one member of said first multiplier-defined restricted set is a number having a numeric value zero.

6. The machine of claim 4 in which each member of said first multiplier-defined restricted set is the negative of the other member.

7. The machine of claim 4 in which each member of said first multiplier-defined restricted can be obtained by shifting the representation element values of the other member.

8. The machine of claim 1 in which said first multiplier-defined restricted set has more than two members.

9. The machine of claim 1 wherein said first multiplier-defined restricted set has a first member and a second member with the following properties:
a. said first member is not an integer multiple of said second member
b. said second member is not an integer multiple of said first member whereby said first multiplier-defined restricted set has at least two members that are related by at least one shift and one addition.

10. The machine of claim 1, further including:
a. a third number represented in a third finite-precision numeric format, said third number being a member of a second multiplier-defined restricted set
b. a fourth number represented in a fourth finite-precision numeric format
c. second multiplier means for computing a second product equal to the product of said third number and said fourth number, where
i. said second multiplier means can compute the product of a first multiplier input and a second multiplier input when the first multiplier input is any number from said second multiplier-defined restricted set and the second multiplier input is said fourth number
ii. said second multiplier means cannot compute the product of a first multiplier input and a second multiplier input when the first multiplier input is not a member of said second multiplier-defined restricted set, the second multiplier input is said fourth number, the first multiplier input has numeric value not equal to zero, and the second multiplier input has numeric value not equal to zero
iii. said second multiplier-defined restricted set has more than one member
whereby said first product and said second product may be computed with lower complexity than if general multiplier means were used to compute each product.

11. The machine of claim 10 wherein said second multiplier-defined restricted set does not include all members of a second unrestricted set, said second unrestricted set including all numbers having said third finite-precision numeric format and not including numbers in other finite-precision numeric formats, whereby each of said first multiplier means and said second multiplier means is neither constant multiplier means nor general multiplier means.

12. The machine of claim 10 wherein said first multiplier-defined restricted set and said second multiplier-defined restricted set do not have any common members.

13. The machine of claim 1, in which:
a. said second number is a member of a second multiplier-defined restricted set
b. said first multiplier means
i. can compute the product of a first multiplier input and a second multiplier input when the first multiplier input is a member of said first multiplier-defined restricted set and the second multiplier input is a member of said second multiplier-defined restricted set
ii. cannot compute the product of a first multiplier input and a second multiplier input when the first multiplier input is not a member of said first multiplier-defined restricted set, the second multiplier input is a member of said second multiplier-defined restricted set, the first multiplier input has numeric value not equal to zero, and the second multiplier input has numeric value not equal to zero
iii. cannot compute the product of a first multiplier input and a second multiplier input when the first multiplier input is a member of said first multiplier-defined restricted set, the second multiplier input is not a member of said second multiplier-defined restricted set, the first multiplier input has numeric value not equal to zero, and the second multiplier input has numeric value not equal to zero
c. said second multiplier-defined restricted set does not include all the members of a second unrestricted set, said second unrestricted set including all numbers having said second finite-precision numeric format and not including numbers in other finite-precision numeric formats
whereby said first multiplier means can have lower complexity than if it must be able to compute the product of said first number and any number in said second unrestricted set.

14. The machine of claim 13 in which said second multiplier-defined restricted set has exactly one member.

15. The machine of claim 14 in which the one member of said second multiplier-defined restricted set has numeric value not equal to zero, positive one, or negative one.

16. The machine of claim 13 in which said second multiplier-defined restricted set has more than one member.

17. A method used in computing one or more sums of products, wherein at least one of said sums of products is not a desired product of two numbers, comprising first multiplication of a first number by a second number to produce a first product equal to the product of said first number and said second number, where:
a. said first number is represented in a first finite-precision numeric format, said first number being a member of a first multiplication-defined restricted set
b. said second number is represented in a second finite-precision numeric format
c. said first multiplication can compute the product of a first multiplication input and a second multiplication input when the first multiplication input is any number from said first multiplication-defined restricted set and the second multiplication input is said second number
d. said first multiplication cannot compute the product of a first multiplication input and a second multiplication input when the first multiplication input is not a member of said first multiplication-defined restricted set, the second multiplication input is said second number, the first multiplication input has numeric value not equal to zero, and the second multiplication input has numeric value not equal to zero
e. said first multiplication-defined restricted set has more than one member
f. said first multiplication-defined restricted set does not include all the members of a first unrestricted set, said first unrestricted set including all numbers having said first finite-precision numeric format and not including numbers in other numeric formats
whereby said first product may be computed with reduced complexity compared to computation of said first product using general multiplication, said general multiplication being able to compute the product of said second number and any member of said first unrestricted set.

18. The method of claim 17 in which said first multiplication-defined restricted set includes the number zero.

19. The method of claim 17 in which said first multiplication-defined restricted set includes a first member with numeric value not equal to zero, positive one, or negative one and a second member with numeric value not equal to zero, positive one, or negative one.

20. The method of claim 17 in which said first multiplication-defined restricted set has exactly two members.

21. The method of claim 20 in which one member of said first multiplication-defined restricted set is the number zero.

22. The method of claim 20 in which each member of said first multiplication-defined restricted set is the negative of the other member.

23. The method of claim 20 in which each member of said first multiplication-defined restricted set can be obtained by shifting the representation element values of the other member.

24. The method of claim 17 in which said first multiplication-defined restricted set has more than two members.

25. The method of claim 17 wherein said first multiplication-defined restricted set has a first member and a second member with the following properties:
a. said first member is not a integer multiple of said second member
b. said second member is not an integer multiple of said first member whereby said first multiplication-defined restricted set has at least two members that are related by at least one shift and one addition.

26. The method of claim 17, further including second multiplication of a third number by a fourth number to produce a second product equal to the product of said third number and said fourth number, where:
a. said third number is represented in a third finite-precision numeric format, said third number being a member of a second multiplication-defined restricted set
b. said fourth number is represented in a fourth finite-precision numeric format
c. said second multiplication method can compute the product of a first multiplication input and a second multiplication input when the first multiplication input is any number from said second multiplication-defined restricted set and the second multiplication input is said fourth number
d. said second multiplication method cannot compute the product of a first multiplication input and a second multiplication input when the first multiplication input is not a member of said second multiplication-defined restricted set, the second multiplication input is said fourth number, the first multiplication input has numeric value not equal to zero, and the second multiplication input has numeric value not equal to zero
e. said second multiplication-defined restricted set has more than one member
whereby said first product and said second product may be computed with lower complexity than if general multiplication methods were used to compute each product.

27. The method of claim 26 wherein said second multiplication-defined restricted set does not include all members of a second unrestricted set, said second unrestricted set including all numbers having said third finite-precision numeric format and not including numbers in other finite-precision numeric formats, whereby each of said first multiplication and said second multiplication is neither constant multiplication nor general multiplication.

28. The method of claim 26 wherein said first multiplication-defined restricted set and said second multiplication-defined restricted set do not have any common members.

29. The method of claim 17 in which:
a. said second number is a member of a second multiplication-defined restricted set
b. the method of said first multiplication
i. can compute the product of a first multiplication input and a second multiplication input when the first multiplication input is a member of said first multiplication-defined restricted set and the second multiplication input is a member of said second multiplication-defined restricted set
ii. cannot compute the product of a first multiplication input and a second multiplication input when the first multiplication input is not a member of said first multiplication-defined restricted set, the second multiplication input is a member of said second multiplication-defined restricted set, the first multiplication input has numeric value not equal to zero, and the second multiplication input has numeric value not equal to zero
iii. cannot compute the product of a first multiplication input and a second multiplication input when the first multiplication input is a member of said first multiplication-defined restricted set, the second multiplication input is not a member of said second multiplication-defined restricted set, the first multiplication input has numeric value not equal to zero, and the second multiplication input has numeric value not equal to zero
c. said second multiplication-defined restricted set does not include all the members of a second unrestricted set, said second unrestricted set including all numbers having said second finite-precision numeric format and not including numbers in other finite-precision numeric formats
whereby the method of said first multiplication can have lower complexity than if it must be able to compute the product of said first number and any number in said second unrestricted set.

30. The method of claim 29 in which said second multiplication-defined restricted set has exactly one member.

31. The method of claim 30 in which the one member of said second multiplication-defined restricted set has numeric value not equal to zero, positive one, or negative one.

32. The machine of claim 29 in which said second multiplication-defined restricted set has more than one member.
